(19) United States
(12) Patent Application Publication
(10) Pub. No.: US 2010/0038880 A1
(43) Pub. Date: Feb. 18, 2010

(54) MODULAR AND/OR CONFIGURABLE WHEELCHAIR APPARATUS

(76) Inventor: Christian Peter Edward BAGG, Calgary (CA)

Correspondence Address: BENNETT JONES LLP, 3400 ONE FIRST CANADIAN PLACE, PO BOX 130, TORONTO, ON, M5X 1A4, CA

(21) Appl. No.: 12/192,708

(22) Filed: Aug. 15, 2008

(51) Int. Cl. B62M 1/14

(52) U.S. Cl. 280/250.1; 16/18 R; 297/217.1

(57) ABSTRACT

A wheelchair comprising a modular and adjustable configuration. The wheelchair comprises a mainframe, a seat assembly, and a caster wing assembly. According to an embodiment, the seat assembly includes adjustable side guards and/or a backrest. According to an embodiment, the wheelchair includes a suspension system coupled between the mainframe and the seat assembly. According to an embodiment, the caster wing assembly includes an adjustment mechanism for adjusting the horizontal and/or vertical position of the footrest with respect to the mainframe. According to another embodiment, the caster wing assembly includes a leg or calf rest member having a comfort shaped profile. According to another embodiment, the seat assembly comprises a structurally independent component. According to another embodiment, the caster wing assembly comprises a structurally independent component. According to another embodiment, the mainframe comprises a structurally independent component.

### FIELD OF THE INVENTION

The present invention relates to wheelchairs, and more particularly, to modular and/or an adjustable or user configurable wheelchair apparatus.

### BACKGROUND OF THE INVENTION

Wheelchairs according to the art comprise a frame having a seat. Two large rear wheels and two small castered front wheels are mounted to the frame. Manually-propelled wheelchairs typically include grip rings attached to the outboard of the rear wheels. The grip rings comprise a ring or wheel structure having a diameter small then the rear wheels. The wheelchair user or rider applies torque to a rear wheel by gripping the corresponding grip ring and pushing it forward or pulling it back to turn the wheel.

Wheelchairs according to the art are typically manufactured or configured based on the size of the user. In essence, the wheelchair tends to be custom made for the user. While such an approach allows the wheelchair to be fitted to the user, there are limitations or deficiencies with such an approach. First, there is limited adjustability in the wheelchair to accommodate changes in the user's physical requirements, for example, growth of the user, the physical abilities of the user change, the requirements of the chair change. Second, the lack of adjustability means that the prescribing and sizing of the chair becomes critical and a specialist will typically need to be engaged. Third, the custom nature of the wheelchair typically translates into longer lead times for delivery/fitting.

Wheelchairs are also being used in activities beyond transportation, such as sporting activities like basketball and track racing. This has given rise to the development of another type of customized or special purpose wheelchairs with features to make them more convenient and competitive in these activities.

Accordingly, there remains a need in the art for a wheelchair that is readily adjustable to the needs of a user. There also remains a need for a wheelchair that is adaptable to multiple types of activities.

### BRIEF SUMMARY OF THE INVENTION

The present invention comprises a modular and/or an adjustable or configuration wheelchair apparatus.

According to one aspect, there is provided a wheelchair comprising: a mainframe, and the mainframe includes a mechanism for connecting right and left rear wheels; a seat support arm, and the mainframe includes a mount for coupling the seat support arm; a seat module, and the seat module includes a seat block for coupling to the mainframe and provides a pivotable connection between the seat module and the mainframe, and the seat module includes a mount for coupling the seat mounting arm; and a caster wing assembly, the caster wing assembly is coupled to the mainframe, and includes a mechanism for connecting a right caster wheel and a mechanism for connecting a left caster wheel.

According to another aspect, there is provided a caster wing assembly for a wheelchair, the caster wing assembly comprises: a mechanism configured for connecting the caster wing assembly to the wheelchair; a leg rest member, the leg rest member being coupled to said connector mechanism; a right caster pod coupled to one end of the leg rest member; a left caster pod coupled to another end of the leg rest member; and the leg rest member including a footrest connector configured for connecting a footrest.

According to another aspect, there is provided a wheelchair frame mainframe assembly for a wheelchair, the mainframe comprises: a pivotable connector for connecting to a seat; a down tube connected to the pivotable connector; a bottom stay member connected to the down tube and to an axle tube, the axle tube being configured for receiving a rear wheel axle; a top stay member connected to the pivotable connector and to the axle tube; the down tube including another connection point for connecting to the seat; and the bottom stay member including a receiver configured for a caster wheel assembly connector.

According to another aspect, there is provided a modular mainframe apparatus for a wheelchair, the modular mainframe apparatus comprises: a first interface configured for connecting a structurally independent seat assembly; a second interface configured for connecting a structurally independent caster wing assembly; and an axle tube for receiving an axle for connecting one or more rear wheels.

According to another aspect, there is provided a seat assembly for a wheelchair, the seat assembly comprises: a seat pan having a first track and a second track for receiving respective seat pivot mounting blocks, and the seat pan having a third track for receiving a seat mount block; a first side guard, and the seat pan including a connector mechanism for connecting the first side guard to a section of the seat pan; a second side guard, and the seat pan including a connector mechanism for connecting the second side guard to another section of the seat pan; and a backrest having a connector mechanism for connecting to the seat pan.

According to another aspect, there is provided a seat height adjustment mechanism.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form a wheelchair according to an embodiment of the present invention;

FIG. 2 is a bottom isometric view of the wheelchair of FIG. 1 according to an embodiment of the present invention;

FIG. 3 is a bottom isometric view of the wheelchair of FIG. 1 with the rear wheels removed;

FIG. 4 is a left side view of a wheelchair according to an embodiment of the invention;

FIG. 5 is a rear view of the mainframe and the seat assembly of the wheelchair of FIG. 4 according to an embodiment of the invention;

FIG. 6 is a side sectional view of the wheelchair of FIG. 5 taken through the line 5-5;

FIG. 7 is a partial bottom view of the wheelchair of FIG. 5 showing the mainframe assembly and torsion bushing assembly according to an embodiment of the present invention;

FIG. 8 is a top view of the wheelchair showing a seat width adjustment mechanism according to an embodiment of the present invention;

FIG. 9 is a front view of the wheelchair of FIG. 8;

FIG. 10 is a rear view of the wheelchair of FIG. 8;

FIG. 11 is a diagrammatic view of a mainframe member according to an embodiment of the invention;

FIG. 12 is a diagrammatic view of a seat module according to an embodiment of the invention;

FIG. 13 is a diagrammatic view of a caster wing module according to an embodiment of the invention;

FIG. 14 is a diagrammatic view of a partial wheelchair assembly illustrating the operation of the seat suspension system according to an embodiment of the invention;

FIG. 15 is a diagrammatic view of partial wheelchair illustrating movement of the caster wing module according to an embodiment of the invention;

FIGS. 16(a) to 16(c) shows in diagrammatic form a seat adjustment mechanism according to an embodiment of the invention; and

FIG. 17 shows a backrest angle adjustment mechanism according to an embodiment of the present invention.

In the drawings, like references indicate like elements or components.

### DETAILED DESCRIPTION OF THE EMBODIMENTS

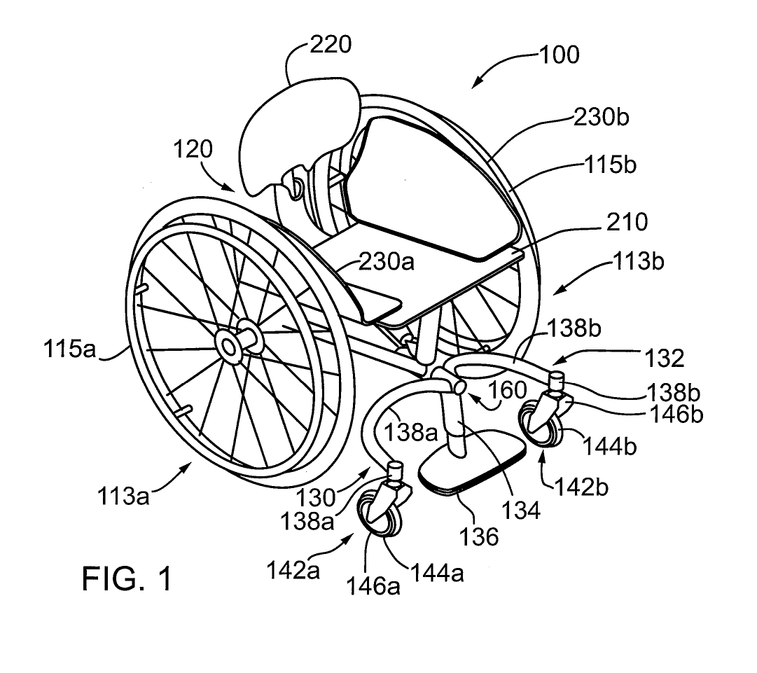

Reference is first made to FIG. 1, which shows an isometric view of a wheelchair according to an embodiment of the present invention, and indicated generally by reference 100. According to an aspect, the wheelchair 100 comprises a modular design and/or configurable apparatus that can be conveniently adjusted and/or configured for different uses and/or different or growing users. As shown, the wheelchair 100 comprises a mainframe member or assembly 110, a seat module 120, and a caster wing module 130. The mainframe member 110 includes an axle 112 for coupling/connecting a pair of rear wheels, indicated individually by references 113a and 113b. Each of the wheels 113 includes a grip ring 115, indicated individually by references 115a and 115b.

In the drawings like references indicate like elements or components.

As will be described in more detail below according to one or more embodiments of the present invention, the mainframe member 110 comprises a module or component which is coupled to the seat module 120 and the caster wing module 130 to provide a configuration which is modular and configurable for different user or rider sizes. According to another aspect, the seat module 120 comprises a structurally independent and an adjustable configuration or user interface which allows the seat module 120 to accommodate a range of users. According to another aspect, the caster wing module 130 comprises a structurally independent and an adjustable configuration or user interface which also allows the caster wing module 130 to accommodate a range of users an interface for coupling to the respective modules. The module interfaces provide a user adaptable or user adjustable configuration for the wheelchair 100 which according to one aspect allows stock components, i.e. the mainframe member 110, the seat module 120, and the caster wing module 130 to be stocked and assembled into a wheelchair which is then adjusted or configured for the size of the user. For example, one chair configuration can be dimensioned for small to medium adult riders, one chair configuration can be dimensioned for large adult riders, and another chair configuration can be dimensioned for child (e.g. pediatric) riders. The adjustability of the respective wheelchair modules provides the capability to adjust the chair to the particular size and characteristics of each individual rider, as will be described in more detail below.

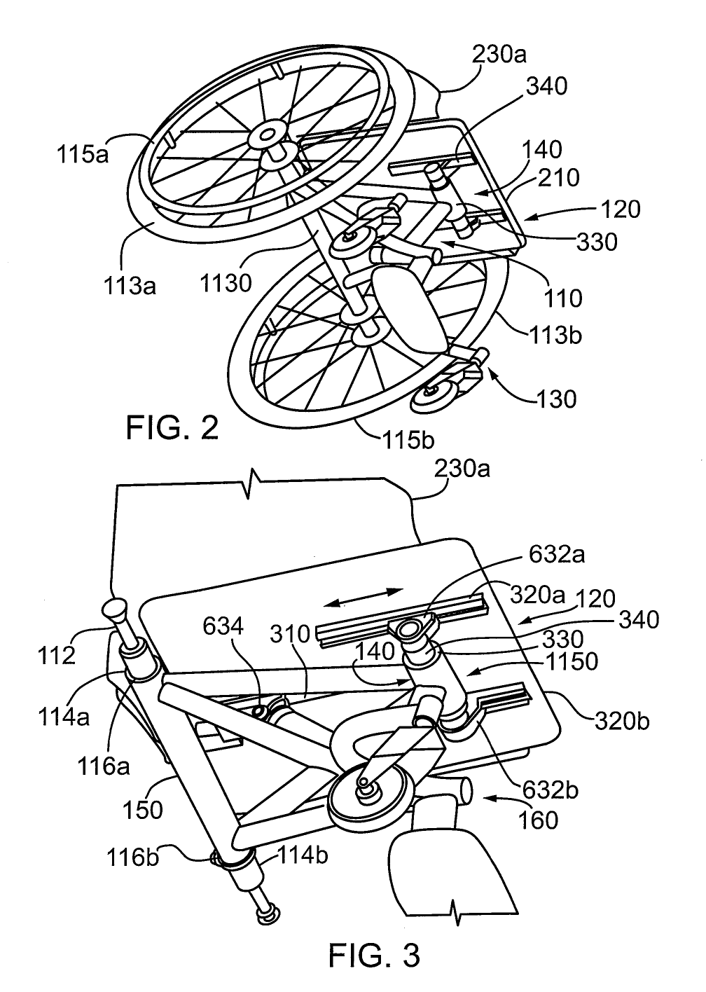

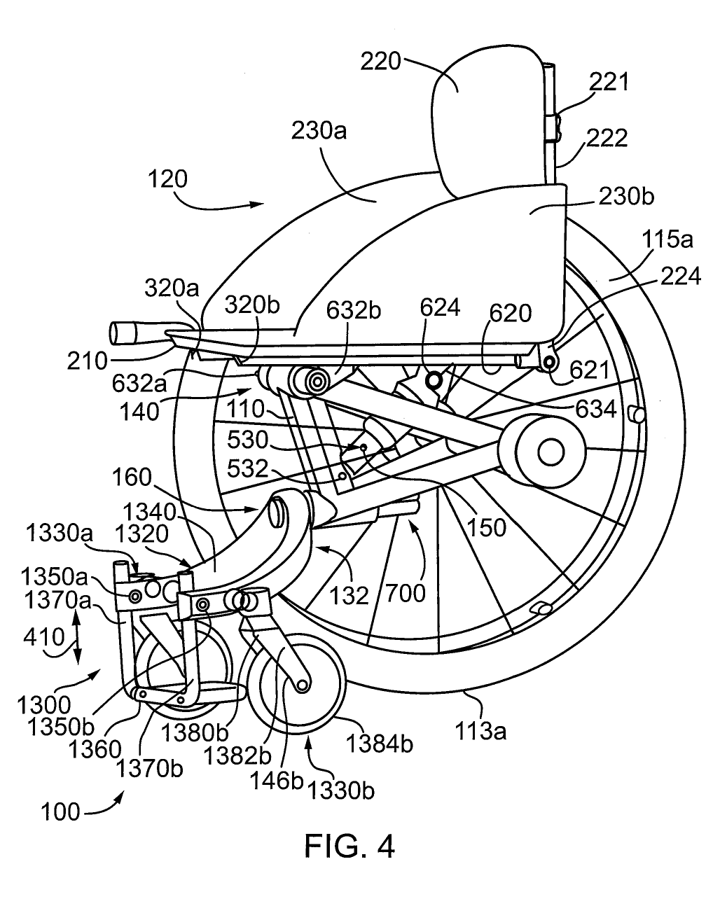

As shown in FIGS. 2 and 3, the mainframe member 110 is coupled to the seat module 120 via a seat pivot assembly 140 at the front end. At the rear end, the seat module 120 is coupled to the mainframe member 110 via a spring/damper assembly 150 according to an embodiment and as shown in FIG. 4. As shown in FIG. 1, the seat module 120 comprises a seat pan 210, a seatback or backrest 220, and side guards 230. The side guards 230 are indicated individually by references 230a and 230b and according to an embodiment comprise a right side guard 230a and a left side guard 230b.

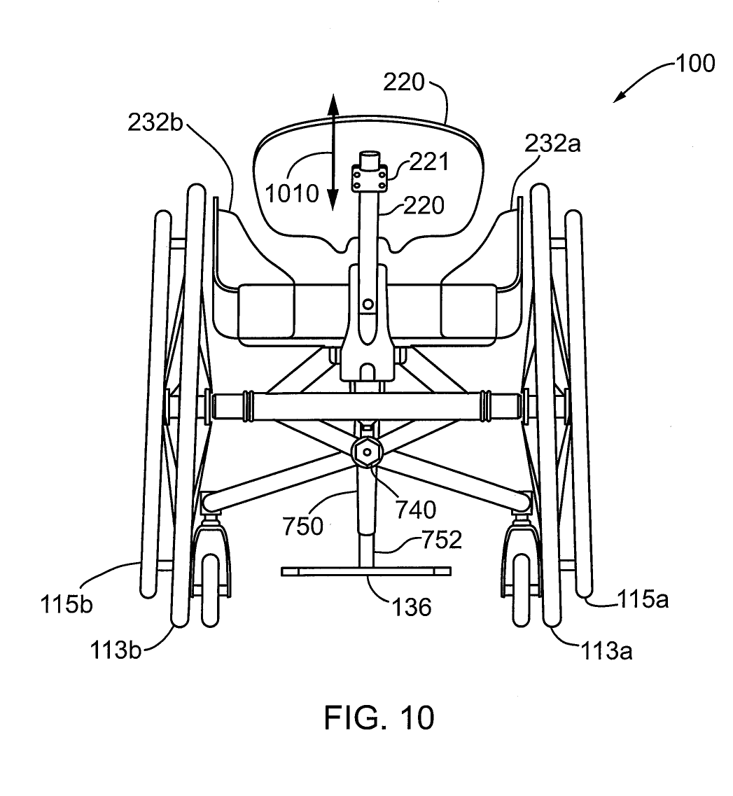

As shown in more detail in FIG. 4, the backrest 220 is attached to a backrest post 222 using a backrest clamp 221. The backrest post 222 is coupled to a backrest support arm 224, and as shown in FIG. 10, the backrest clamp 221 allows the height of the backrest 220 (i.e. the “Seatback Height”) to be adjusted vertically, i.e. in the direction indicated by arrow 1010. According to an embodiment, the wheelchair 100 includes a backrest primary angle adjustment mechanism indicated generally by reference 620 in FIG. 4. As shown in FIG. 4, the backrest support arm 224 is coupled to the backrest primary angle adjustment mechanism 620 at a pivot point 621. An embodiment of the backrest primary angle adjustment mechanism 620 is described in more detail below with reference to FIG. 17.

As shown in FIG. 4, the seat assembly 120 includes a pair of seat pivot blocks 632 (indicated individually as 632a and 632b) and a seat pan shock mount 634. The seat pivot blocks 632 connect to the seat pivot assembly 140 (i.e. are connected to respective ends of the seat pivot shaft 340) and are configured to attach the front of the seat assembly 120 to the mainframe 110 and provide a pivot point 633 for adjusting the angle of the seat pan 210 and/or the height of the seat pan 210. According to an embodiment, the seat pivot blocks 632 are mounted or configured in corresponding slot tracks 320, indicated individually by references 320a and 320b in FIG. 3. The seat pan shock mount 634 is also configured in a slot track 310 as shown in FIG. 3. According to an embodiment, the slot tracks 310, 320 comprise a “T-slot” configuration, and the seat pivot blocks 632 and the seat pan shock mount 634 are configured to fit and slide in the respective T-slot tracks 320 and 310.

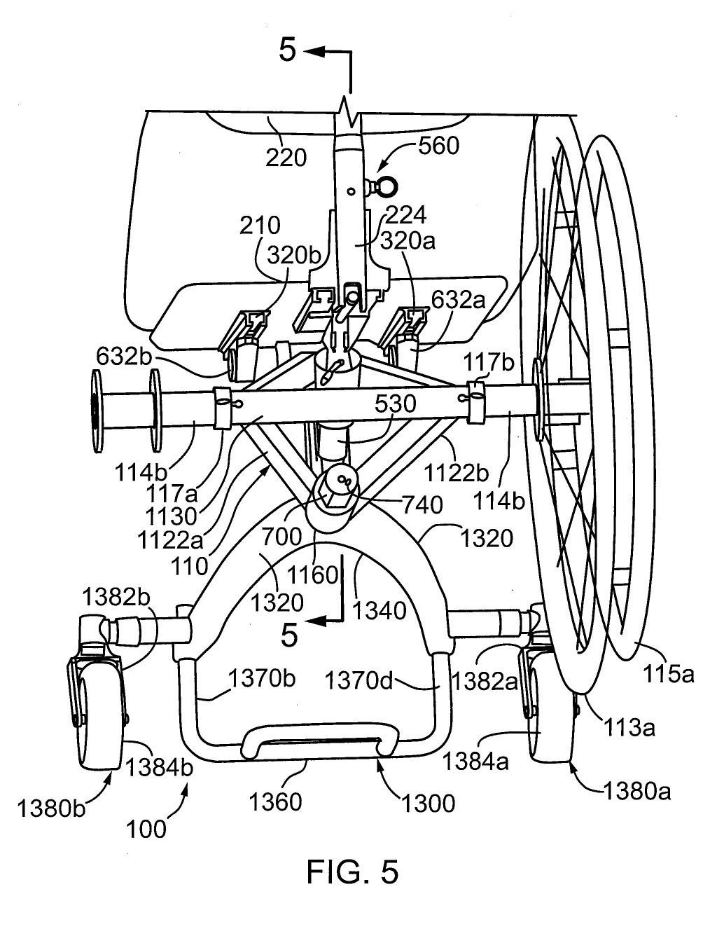

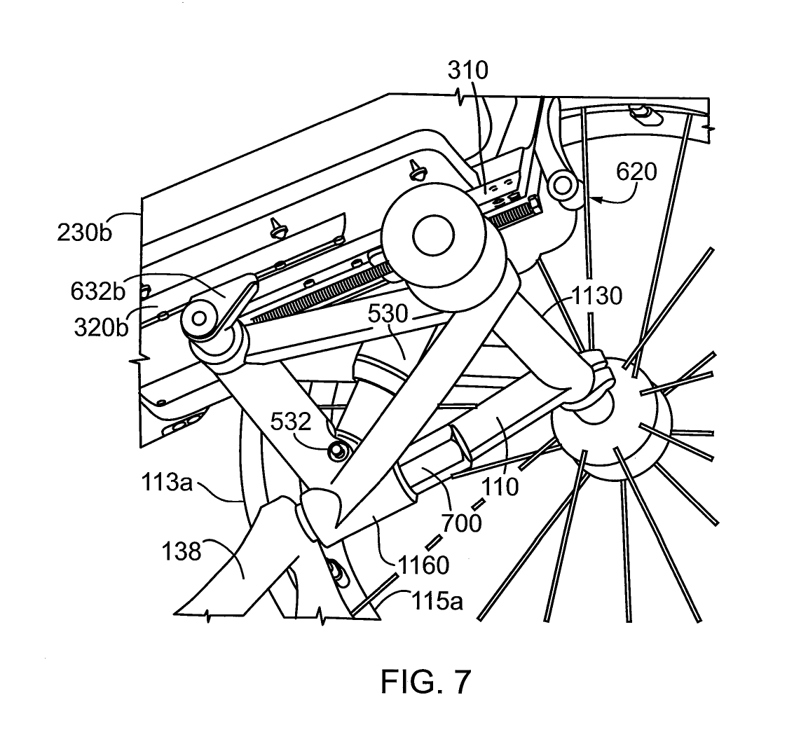

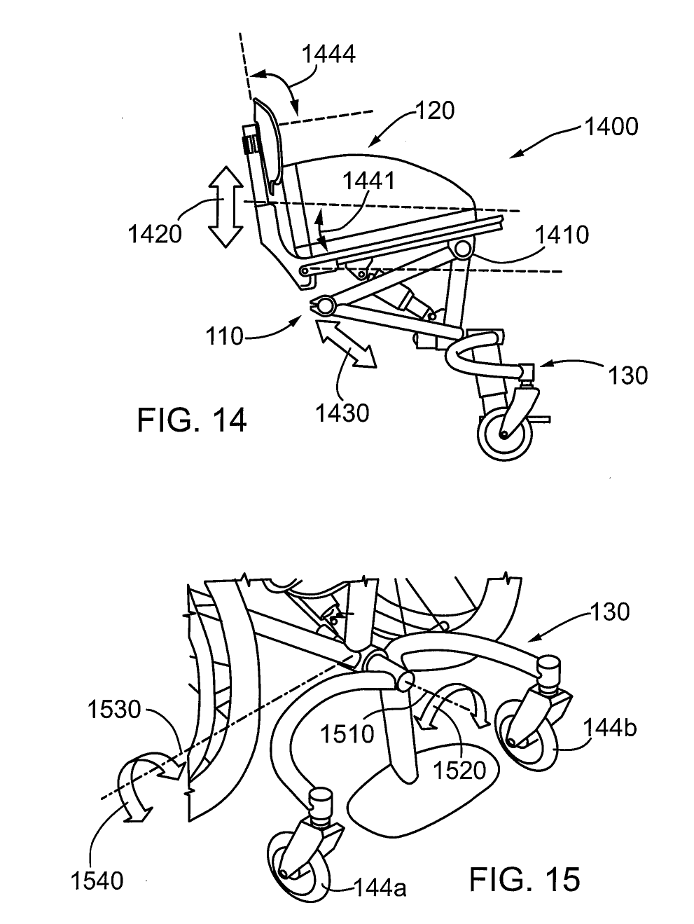

Referring again to FIG. 4, the seat pan shock mount 634 is coupled to the bottom of the seat pan 210 through the slot track 310 (for example, as depicted in FIG. 3 and FIG. 7). According to an embodiment the seat pan shock mount 634 is coupled through the backrest primary angle adjustment mechanism 620 at a pivotable attachment point 624. As shown in FIG. 17, the backrest primary angle adjustment mechanism 620 comprises a threaded rod 1710 which is coupled to the seat pan shock mount 634 through a barrel nut 1720. As shown, one end of the threaded rod 1710 is coupled to the backrest support 224 and the end of threaded rod 1710 includes a socket or other type of screw head (as also shown in FIG. 5) which allows the threaded rod 1710 to be screwed or turned, clockwise and counter-clockwise. Turning or screwing the threaded rod 1710 moves the backrest support 224 forwards/backwards which, in turn, changes the angle of the backrest post 222 and the backrest 220, and allows the “Backrest Angle” parameter to be adjusted as indicated by reference 1444 in FIG. 14.

According to another aspect, the seat pivot blocks 632 and the seat pan shock mount 634 can be configured to accept one or more respective spacer blocks (not shown). The spacer blocks allow adjustment of a “Front Seat Height” parameter for adjusting the wheelchair 100 to a user or rider, and may comprise various height blocks.

According to an aspect, the arrangement of the seat pan shock mount 634 and the T-slot track 310 allows the “Dump Angle” of the wheelchair 100 (i.e. the seat) to be adjusted by moving the seat pan shock mount 634 fore and aft in the track 310. In FIG. 14, the “Dump Angle” is illustrated by arrow 1441. According to another aspect, the configuration of the seat pivot blocks 632 provides fore/aft movement in the T-slot tracks 320 which allows the “Center of Gravity” or “CG” position of the wheelchair 100 to be adjusted for the user.

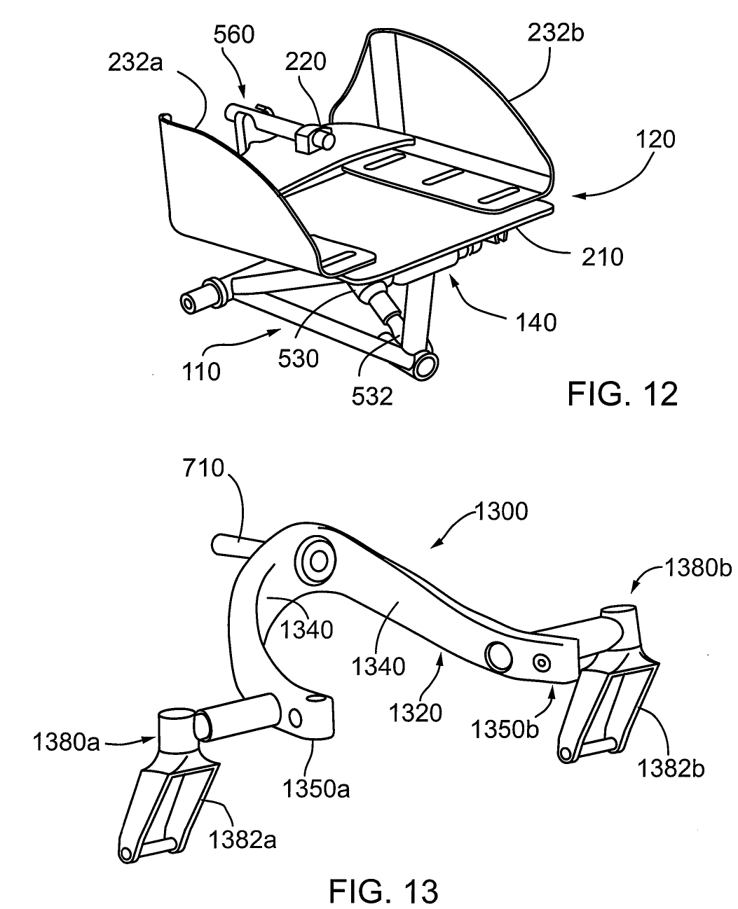

Referring to FIG. 5, the backrest support arm 224 according to an embodiment includes a backrest storage pivot mechanism indicated generally by reference 560. The backrest pivot mechanism 560 allows the backrest 220 to be “folded over” into a storage position, for example, as depicted in FIG. 12. According to an aspect, the seat module 120 is coupled to the mainframe 110 and folded over for shipping and/or inventory stock or storage. The wheelchair 100 is then assembled according to a user configuration or specification by adding wheels 113 (FIG. 1) and a caster wing module 1300 (FIG. 4). The final adjustments, e.g. seat width, seat height, dump angle, are made as described above and below.

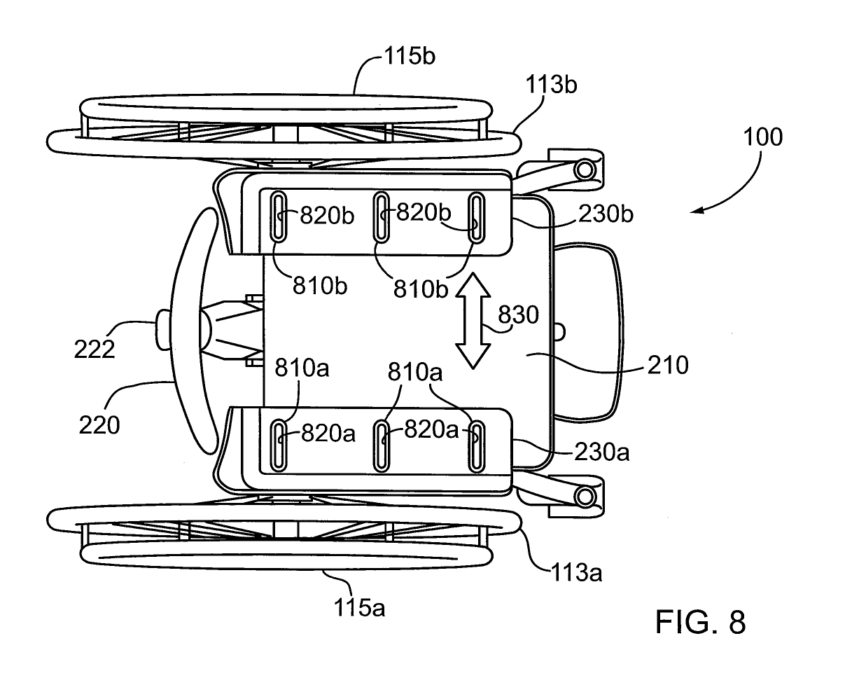

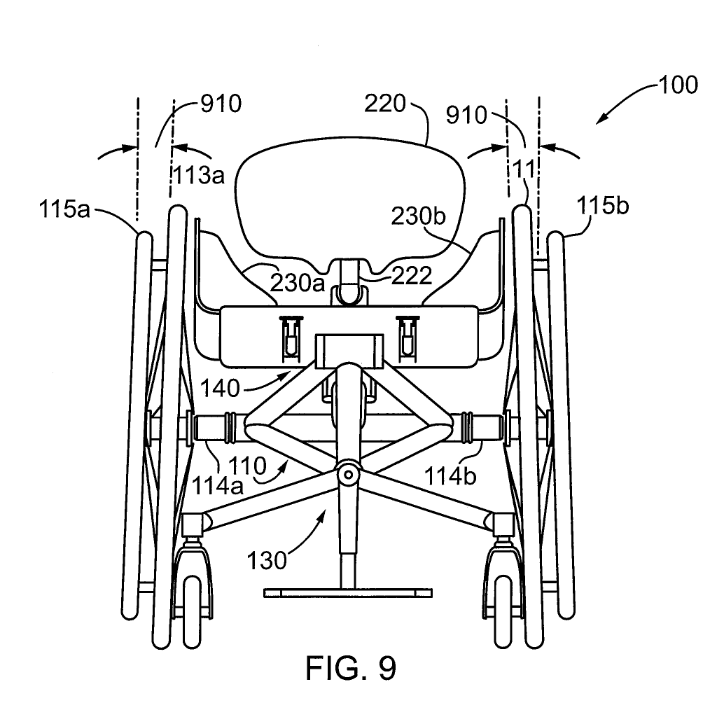

According to another aspect, the “Seat Width”, i.e. width of the seat 120, is adjustable or configurable for the user or rider. According to an embodiment and as depicted in FIG. 8, each of the side guards 230a and 230b include seat width adjuster slots indicated by references 810a and 810b, respectively. The seat width adjuster slots 810a and 810b communicate with corresponding adjuster slots 820a and 820b formed or cut in the seat pan 210 as depicted in FIG. 8. The side guards 230 are coupled or engaged to the seat pan 210 using suitable fasteners (for example, recessed bolt/nut pairs) inserted through the respective slots 810 and 820. The seat width is adjusted by moving the side guards in or out as indicated by arrow 830 in FIG. 8. Once the correct or desired seat width is made, the fasteners are tightened to secure the side guards 230 into position, for example, as depicted in FIG. 9 (front view) and FIG. 10 (rear view). According to another aspect, the “Seat Depth”, i.e. depth of the seat 120, is adjustable by substituting a seat pan 210 with another depth and/or width dimension. For example, a seat width adjustable between 10″ to 14″ would be suitable for a pediatric rider application; a seat width adjustable between 12″ to 16″ would be suitable for a small size adult rider; and a seat width adjustable between 14″ to 18″ would be suitable for a medium size adult rider.

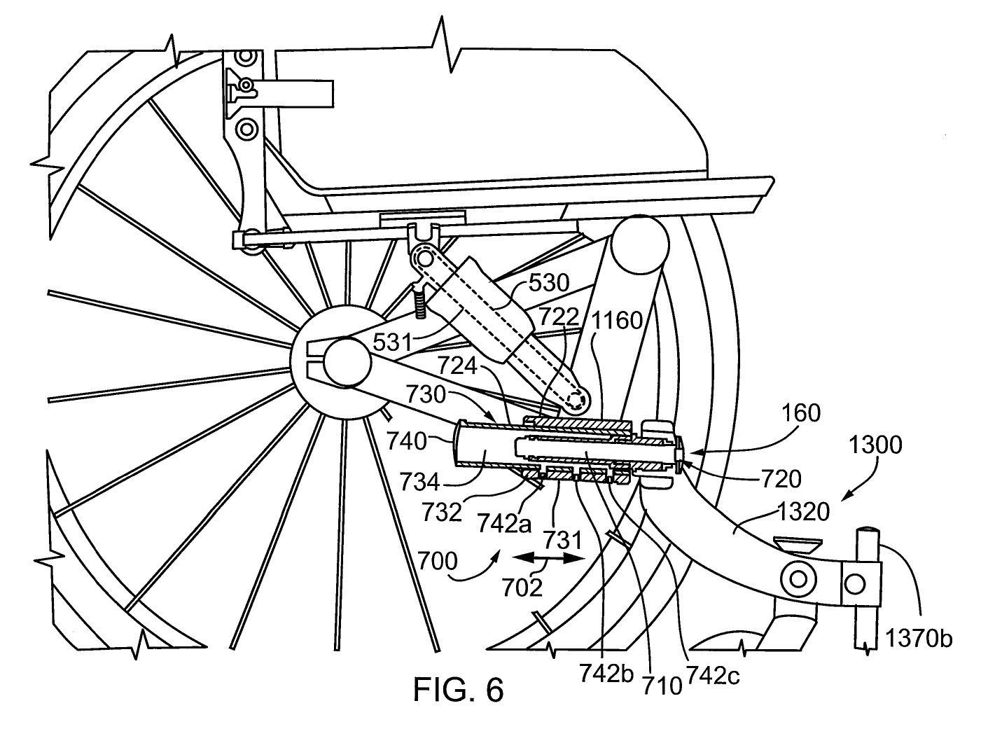

According to an embodiment, the mainframe member 110 includes a spring or damper unit as shown in FIGS. 4 to 6 and indicated generally by reference 530. The spring or damper unit 530 has one end coupled to the seat pan shock mount 634 (and the backrest primary angle adjuster 620) at the pivot point 624 (FIG. 4). The other end of the damper unit 530 is coupled to the mainframe member 110 at a frame shock mount indicated generally by reference 532. The damper unit 530 provides a suspension function to effectively isolate the rider from undulations thereby enhancing rider comfort as well as reducing overall rider fatigue. According to an embodiment, the damper unit 530 comprises an air shock component which is adjustable for spring rate and/or damping. The air shock 530 is adjusted, for example, according to rider weight and/or operating conditions. According to another aspect, the damper 530, i.e. air shock, is configured with a lockout function which allows the rider to “lockout” the suspension. According to another embodiment, the damper unit or component 530 is replaced by a seat support arm, rod or shaft which is substantially rigid. The seat support arm is coupled at one end to the frame shock mount 532 and at the other end to the seat pan shock mount 634. An exemplary seat support arm configuration is shown in broken outline and indicated by reference 531 in FIG. 6.

Reference is also made to FIG. 14, which illustrates operation of the seat suspension according to an embodiment of the invention with a partial wheelchair assembly (i.e. the wheelchair 100 without the rear wheels 113 attached) which is indicated generally by reference 1400. The wheelchair assembly 1400 comprises the seat assembly 120 and the caster wing module 130 coupled to the mainframe module 110. In operation, the seat assembly 120 pivots about the seat pivot point 1410 (i.e. the pivot point 633 in FIG. 6) and will move up and down as indicated by an arrow 1420, for example, in response to forces imparted by the user and/or forces generated from the contact of the wheel(s) 113 (FIG. 1) and/or the caster wing module 130 and transmitted through the mainframe 110. In response, the spring or damper component 530 (e.g. an air shock) moves fore and aft as indicated by arrow 1430 and serves to dampen or minimize movement of the seat assembly 120 to cushion the user from undulations in the surface on which the wheelchair is running.

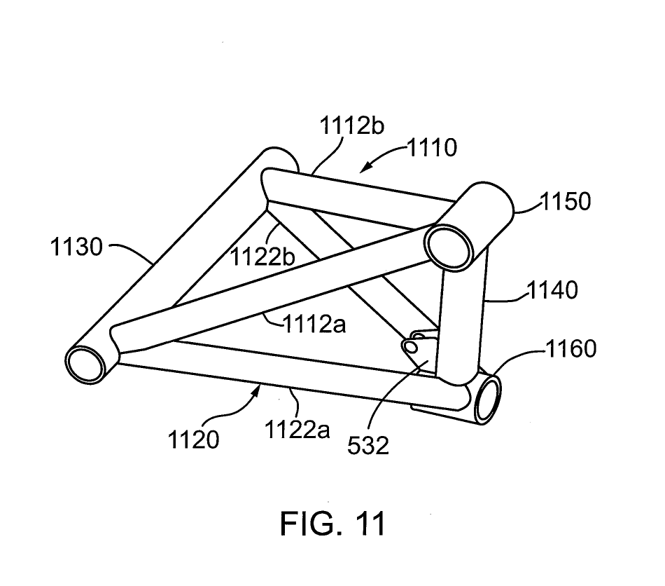

Reference is next made to FIG. 11, which shows an embodiment of the mainframe member 110 according to an embodiment of the invention. As shown, the mainframe 110 comprises a top stay member 1110, a bottom stay member 1120, an axle tube 1130, and a vertical or down tube 1140. The top stay member 1110 comprises a first section or tube 1112a and a second section or tube 1112b. One end of each top stay tube 1112a, 1112b is connected (for example, welded or otherwise joined) to respective sections on the axle tube 1130. The axle tube 1130 is configured to receive the axle 112 (FIG. 3). According to an embodiment, the axle (FIG. 3) comprises a “quick release” axle for connecting/disconnecting the rear wheels 113 (FIG. 1). According to another aspect, the axle 112 is configured with a pair of camber plugs or tubes 114, indicated individually by references 114a and 114b in FIG. 3, for configuring the wheels 113 with a “camber angle”, corresponding to the angle of the wheel with respect to a vertical plane. By providing different angle camber plugs 114, the camber angle of the rear wheels 113 can be adjusted, for example, as depicted and indicated by reference 910 in FIG. 9. As shown in FIG. 3, the axle 112 is also provided with a pair of axle clamps 116, indicated by reference 116a and 116b, for securing the camber plugs 114 to the axle tube 1130. In FIG. 5, the axle clamps are indicated by references 117a and 117b.

Referring back to FIG. 11, the other end of each top stay tube 1112a, 1112b is connected (for example, welded) or otherwise joined to a seat pivot bearing housing indicated by reference 1150. The seat pivot bearing housing 1150 receives a seat pivot bearing 330 (FIG. 3) which mounts a seat pivot shaft or tube 340 (FIG. 3). The seat pivot shaft 340 is coupled at each to the respective seat pivot block 632a and 632b (FIG. 3). The seat pivot bearing housing 1150, the seat pivot bearing 330, the seat pivot shaft 340 comprise the seat pivot assembly indicated by reference 140, for example, in FIGS. 2, 3 and 9. As described, the seat pivot shaft 340 is attached or coupled to the respective seat pivot blocks 632 to connect the seat assembly 120 (i.e. the front section of the seat) to the mainframe 110.

Referring again to FIG. 11, the bottom stay 1120 comprises a first section or member (i.e. tube) 1122a and a second section or member (i.e. tube) 1122b. One end of each bottom stay tube 1122a, 1122b is connected (for example, welded) to respective sections on the axle tube 1130 and the ends of the top stay tubes 1112a and 1112b. The other end of each bottom stay tube 1122a, 1122b is connected (for example, welded) or otherwise joined to a torsion bushing housing receiver indicated by reference 1160. The torsion bushing housing receiver 1160 is configured to receive a torsion bushing housing 700 (FIG. 6) and couple the caster wing module 130 (FIG. 1), as will be described in more detail below. The mainframe 110 also includes the frame shock mount 532 for coupling the spring or damper component 530 (or a seat support arm or rod 531) as described above with reference to FIG. 5.

According to an embodiment, the top stay member 1110 forms a substantially triangular configuration or structure with the axle tube 1130. Similarly, the bottom stay member 1120 forms a substantially triangular configuration or structure with the axle tube 1130. According to another aspect, the top stay tube 1112a and the bottom stay tube 1122a and the down tube 1140 form a substantially triangular configuration or structure. Similarly, the top stay tube 1112b and the bottom stay tube 1122b and the down tube 1140 form a substantially triangular configuration or structure. According to an embodiment, the mainframe member 110 is manufactured from aircraft grade aluminum. According to another embodiment, the mainframe member 110 is manufactured from lightweight high strength carbon fiber composite material. According to another aspect, the mainframe 110 comprises a structurally independent component, which is coupled to the seat assembly 120, the caster wing assembly 130 and the rear wheels 113 to form a wheelchair.

Reference is made back to FIG. 1, and in particular the caster wing module indicated by reference 130. According to an embodiment, the caster wing module 130 comprises a leg rest member 132, a footrest height adjustment mechanism 134, and a footrest 136. The leg rest wing 132 comprises a right leg rest wing 138a and a left leg rest wing 138b. The end of the each leg rest wing 138 includes a corresponding caster pod 140, indicated individually by respective references 140a and 140b. The caster pods 140 couple a respective caster wheel assembly 142 (indicated individually by references 142a and 142b) comprising a caster wheel 144 (indicated individually by references 144a and 144b) connected to a caster fork 146 (indicated individually by references 146a and 146b). According to one embodiment, the footrest height adjustment mechanism 134 comprises a telescoping mechanism having an outer tube and an inner tube according to an embodiment. The footrest 136 is attached or fastened to one end of the inner tube. The other end of the inner tube is engaged with the outer tube and configured to move up/down to adjust the height of the footrest. The footrest height adjustment mechanism 134 includes a locking mechanism (not shown) for locking the footrest 136 into position once the correct height is achieved.

Reference is next made to FIGS. 4, 5 and 13, which show a caster wing module 1300 according to another embodiment of the invention. The caster wing module 1300 comprises a leg rest wing or member 1320. Each end of the leg rest wing 1320 includes a corresponding caster pod 1380, indicated individually by respective references 1380a and 1380b. According to one aspect, the leg rest wing or member 1320 is formed with a rectangular cross-section or vertical profile 1340 as shown in FIG. 13. The caster wing module 1300 according to this embodiment is also shown installed on the wheelchair 100 as depicted in FIGS. 4 and 5. As shown, the profile 1340 of the leg rest member 1320 provides a comfort shaped surface that is more comfortable for a user to rest their lower legs or calves against as compared to a conventional round tube or member. The conventional round cross-section provides a smaller surface area against which the calf or lower leg of a user would rest that can result in a more focused or pronounced pressure point. The profile 1340 of the leg rest member or wing 1320 spreads the pressure of user's calf across the flattened or profiled surface. The flattened or profiled surface 1340 of the leg rest wing 1320 can be further fitted with a padded strip or other type of cushioning (not shown). Each caster pod 1380 comprises a caster fork 1382 (indicated individually by references 1382a and 1382b) and a caster wheel 1384 (indicated individually by references 1384a and 1384b). Each end of the leg rest wing or member 1320 also includes a footrest height adjustment mechanism 1350, indicated individually by respective references 1350a and 1350b, for adjusting the height of the footrest 1360 for example as described above with reference to FIG. 4. As shown in FIG. 4, the footrest 1360 includes a pair of rods or tubes 1370, indicated individually by respective references 1370a and 1370b. The footrest tubes 1370 are slidably engaged by the respective height adjustment mechanism 1350 and the footrest 1360 is secured into position by locking the respective height adjustment mechanisms 1350 (for example, a screw actuated locking collar).

According to an embodiment, the caster wing assembly or module 130 or 1300 is detachably coupled to the mainframe member 110 via a quick release mechanism as shown in FIG. 6 and indicated generally by reference 160. According to this aspect, the caster wing module 130 can be quickly and easily removed from the wheelchair 100 (i.e. the mainframe member 110). This provides a more collapsible and easily transportable wheelchair, as the caster wing module 130 can account for a third of the total weight of the wheelchair 100. According to another aspect, the caster wing module 1300 can be coupled to and shipped together with the mainframe 110 for example in an upside down orientation or without the footrest. According to another aspect, different types of caster wing modules 130 may be used with the wheelchair 100, for example, an “off-road” caster wing module, and a racing caster wing module.

According to an embodiment and as shown in FIGS. 6 and 7, the caster wing module 130 includes a torsion bushing mechanism 700. The torsion bushing mechanism 700 is configured to fit in the torsion bushing receiver 1160 (FIG. 11) and is configured with the quick release mechanism 160. According to an embodiment and as shown in FIG. 6, the quick release mechanism 160 comprises a wing pin 710 and an actuator button 720. As shown, the torsion bushing mechanism 700 comprises a torsion bushing housing 730 which is configured with a torsion bushing indicated by reference 731. According to an embodiment, the wing pin 710 is configured as a male plug that indexes into a mating recess or channel 732 in the torsion bushing 731. According to an embodiment, the pin 720 includes a retractable ball or pin 722 which is actuated by depressing the button 720 and engages the channel 732. According to another aspect, the wing pin 720 includes a flange or rim 724 to prevent accidental disengagement of the caster wing assembly 130 from the wheelchair 100. According to an embodiment, the torsion bushing 731 comprises an elastomer bushing, for example, made from urethane rubber. The torsion bushing mechanism 700 is configured to provide fore/aft movement (i.e. adjustment) of the caster wing module 130 as indicated by arrow 702 in FIG. 6. According to an embodiment, the torsion bushing housing 730 includes one or more threaded set holes 742, indicated individually by reference 742a, 742b and 742c to lock the torsion bushing housing 730 into an adjustable lateral position (for example, indicated by arrow 702 in FIG. 6) using, for example, one or more hex cap or set screws which inserted and project through respective screw holes 743, indicated individually by references 743a, 743b and 743c, in the torsion bushing receiver 1160, as shown in FIG. 6.

According another aspect, the torsion bushing 731 comprises a deformable material (i.e. an elastomer) which provides a dampening function to vibrations that may be transmitted from the caster wheel assembly 130 to the mainframe 110. According to a further aspect, the elastomer bushing 731 allows the caster wing module 130 to rotate or move about an axis 1510 longitudinal to the wheelchair 100 as indicated by arrow 1520 in FIG. 15. According to another aspect, the deformability of the bushing 731 provides a limited amount of movement or “give” about an axis 1530 lateral to the wheelchair 100 as indicated by arrow 1540 in FIG. 15. This allows for some vertical travel of the caster wheels 144 and provides an additional suspension or dampening action to overcome irregularities in the surface contacted by the caster wheels 144, thereby enhancing rider comfort. According to another aspect, the fore/aft positional adjustability (as described above) of the torsion bushing mechanism 700 with respect to the mainframe 110 allows the “Front Bend Angle” of the caster wing assembly 130 (FIG. 1) or 1300 (FIG. 4) to be adjusted for the user.

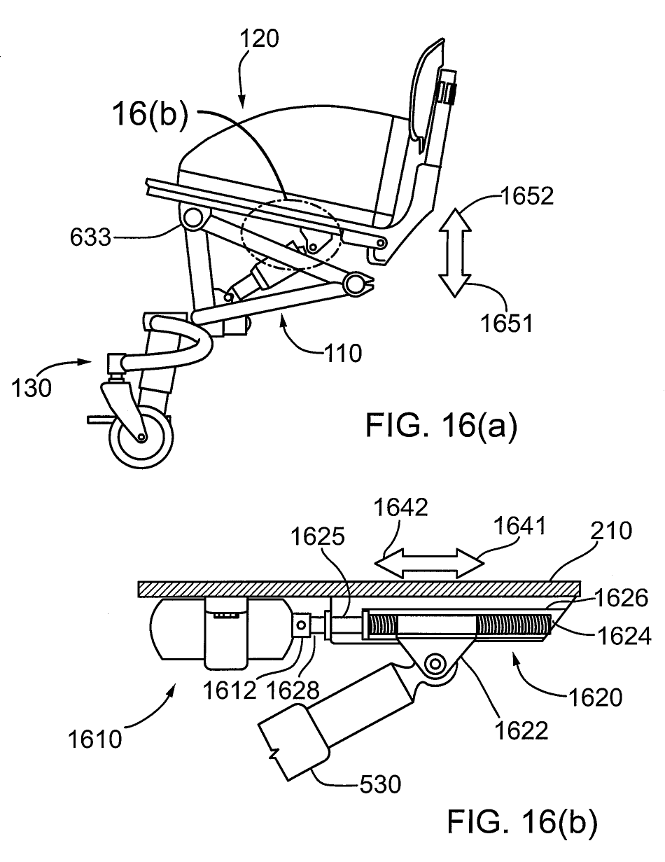

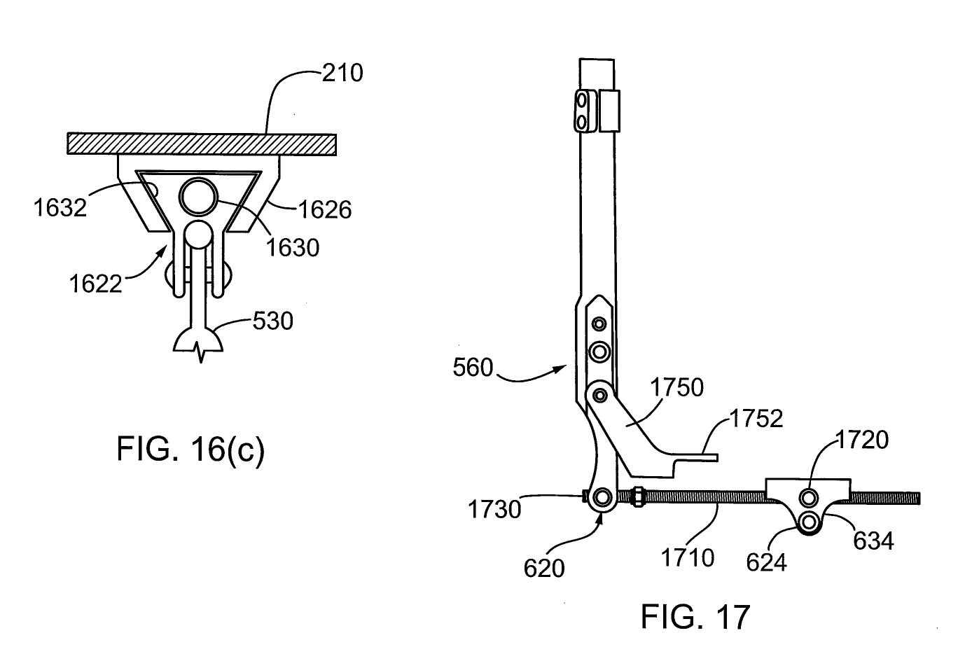

According to another aspect, the wheelchair 100 can be fitted or configured with a motorized or powered seat adjustment mechanism. A motorized seat adjustment mechanism is depicted in FIGS. 16(a) to 16(c) and indicated generally by reference 1600. The motorized seat adjustment mechanism 1600 comprises a motor 1610 and an actuator 1620. According to an embodiment, the motor 1610 comprises a DC motor that is powered by a rechargeable battery (not shown) carried onboard the wheelchair 100. The actuator 1620 comprises a seat pan shock mount 1622, a drive shaft 1624 and a mounting bracket 1626. The mounting bracket 1626 supports the drive shaft 1624 and is attached or other affixed to the bottom of the seat pan 210. The motor 1610 includes a shaft 1612 that is operatively coupled or connected to one end 1628 of the drive shaft 1624, and the end of the drive shaft 1624 is supported by a bearing 1625 and is turned by the motor 1610. According to an embodiment, the drive shaft 1624 comprises a ball screw and the seat pan shock mount 1622 includes a threaded bore indicated by reference 1630 in FIG. 16(c) which matches the threading of the drive shaft 1624. According to an embodiment, the mounting bracket 1626 includes a channel 1632 (for example, a dovetail channel) configured for receiving and further supporting the seat pan shock mount 1622. In operation, rotation of the motor shaft 1612 in clockwise direction turns the drive shaft 1624 which causes the seat pan shock mount 1622 to move in a direction indicated by reference 1641. This results in the rear of the seat being lowered as the front of the seat pivots about the pivot point 633, i.e. the seat moves downwards in the direction of arrow 1651. When the motor shaft 1612 is rotated in the opposite direction, i.e. counter-clockwise, the seat pan shock mount 1622 moves in a direction indicated by arrow 1642 causing the rear of the seat to be raised (i.e. moved in the direction of arrow 1652) as the front of the seat pivots about the pivot point 633. The motor 1610 includes a controller and activation switch or other control (not shown) which are used by the user to raise/lower the seat.

The present invention may be embodied in other specific forms without departing from the spirit or essential characteristics thereof. Certain adaptations and modifications will be obvious to those skilled in the art. Therefore, the presently discussed embodiments are considered to be illustrative and not restrictive.

What is claimed is:

1. A wheelchair comprising:
a mainframe, and said mainframe including a mechanism for connecting right and left rear wheels;
a seat support arm, and said mainframe including a mount for coupling said seat support arm;
a seat module, said seat module including a seat block for coupling to said mainframe and providing a pivotable connection between said seat module and said mainframe, and said seat module including a mount for coupling said seat mounting arm; and
a caster wing assembly, said caster wing assembly being coupled to said mainframe, and including a mechanism for connecting a right caster wheel and a mechanism for connecting a left caster wheel.

2. The wheelchair as claimed in claim 1, wherein caster wing assembly includes a mechanism configured to releasably couple said caster wing assembly to said mainframe.

3. The wheelchair as claimed in claim 1, further including a mechanism configured to positionally adjust said caster wing assembly with respect to said mainframe.

4. The wheelchair as claimed in claim 1, wherein said caster wing assembly is structurally independent of said mainframe.

5. The wheelchair as claimed in claim 1, wherein said seat module comprises a seat pan, a backrest, and right and left side guards, and said backrest being coupled to said seat pan, and said right and left side guards being configured to provide an adjustable width between said side guards.

6. The wheelchair as claimed in claim 5, wherein said seat module includes a backrest angle adjustment mechanism, said backrest angle adjustment mechanism being configured for adjusting the angle of said backrest.

7. The wheelchair as claimed in claim 5, wherein said seat module is configured to be structurally independent of said mainframe and said caster wing assembly.

8. The wheelchair as claimed in claim 1, wherein said seat support arm comprises a shock absorber component configured to dampen movement of said seat module.

9. A caster wing assembly for a wheelchair, said caster wing assembly comprising:
a mechanism configured for connecting the caster wing assembly to the wheelchair;
a leg rest member, said leg rest member being coupled to said connector mechanism;
a right caster pod coupled to one end of said leg rest member;
a left caster pod coupled to another end of said leg rest member; and
said leg rest member including a footrest connector configured for connecting a footrest.

10. The caster wing assembly as claimed in claim 9, wherein said leg rest member includes a surface for resting against a rider's lower legs, and said surface having a shaped profile for rider comfort.

11. The caster wing assembly as claimed in claim 9, wherein said connector mechanism comprises a connector mechanism configured to detachably couple the caster wing assembly to the wheelchair.

12. The caster wing assembly as claimed in claim 9, wherein said footrest connector is configured to provide vertical adjustment of the footrest connected to the caster wing assembly.

13. A mainframe assembly for a wheelchair, said mainframe comprising:
a pivotable connector for connecting to a seat;
a down tube connected to said pivotable connector;
a bottom stay member connected to said down tube and to an axle tube, said axle tube being configured for receiving a rear wheel axle;
a top stay member connected to said pivotable connector and to said axle tube;
said down tube including another connection point for connecting to the seat; and
said bottom stay member including a receiver configured for a caster wheel assembly connector.

14. The mainframe assembly as claimed in claim 13, wherein said caster wheel assembly connector comprises a torsion bushing, and said torsion bushing comprises a housing configured for said receiver and having a channel for engaging a connector pin on said caster wheel assembly.

15. The mainframe assembly as claimed in claim 14, wherein the channel of said torsion bushing includes an interior sleeve formed of a deformable material, and said deformable material being adapted to dampen vibrations and movement transmitted from said caster wheel assembly through the connector pin.

16. The mainframe assembly as claimed in claim 13, wherein said other connection point is configured for connecting a seat support arm, and said connection point positions said seat support arm substantially centrally within the mainframe assembly.

17. The mainframe assembly as claimed in claim 13, wherein said top stay member and said axle tube forms a generally triangular shaped configuration.

18. The mainframe assembly as claimed in claim 13, wherein said bottom stay member and said axle tube forms a generally triangular shaped configuration.

19. A modular mainframe apparatus for a wheelchair, said modular mainframe apparatus comprising:
a first interface configured for connecting a structurally independent seat assembly;
a second interface configured for connecting a structurally independent caster wing assembly; and
an axle tube for receiving an axle for connecting one or more rear wheels.

20. The modular mainframe apparatus as claimed in claim 19, wherein said first interface comprises a mechanism configured for connecting to a front section of the structurally independent seat assembly, and another connection point configured to connecting to a rear section of the structurally independent seat assembly.

21. The modular mainframe apparatus as claimed in claim 19, wherein said second interface comprises a coupling mechanism for releasably engaging said structurally independent caster wing module.

22. The wheelchair as claimed in claim 1, further including a seat height adjustment mechanism.

23. A seat assembly for a wheelchair, said seat assembly comprising:
a seat pan having a first track and a second track for receiving respective seat pivot mounting blocks, and said seat pan having a third track for receiving a seat mount block;
a first side guard, and said seat pan including a connector mechanism for connecting said first side guard to a section of said seat pan;
a second side guard, and said seat pan including a connector mechanism for connecting said second side guard to another section of said seat pan; and
a backrest having a connector mechanism for connecting to said seat pan.

24. The seat assembly as claimed in claim 23, wherein each of said connector mechanisms include an adjustment mechanism configured for adjusting the position of the associated side guard with respect to the seat pan to provide an adjustable width dimension between said first and said second side guards.

25. The seat assembly as claimed in claim 23, wherein said connector mechanism for said backrest includes a backrest angle adjustment mechanism.
